(19) United States
(12) Patent Application Publication
(10) Pub. No.: US 2018/0009422 A1
(43) Pub. Date: Jan. 11, 2018

(54) SELECTIVE HIGH FLOW PRESSURE SUPPLY FOR VEHICLE STABILITY CONTROL SYSTEMS WITHOUT HIGH PRESSURE ACCUMULATORS

(71) Applicant: Robert Bosch GmbH, Stuttgart (DE)

(72) Inventors: John Hobbs, Brighton, MI (US); Rick Robinson, Farmington Hills, MI (US); Douglas Patterson, Summerville, SC (US)

(21) Appl. No.: 15/544,305

(22) PCT Filed: Jan. 25, 2016
(86) PCT No.: PCT/US16/14726

§ 371 Date: Jul. 18, 2017

Related U.S. Application Data
(60) Provisional application No. 62/107,562, filed on Jan. 26, 2015.

(51) Int. Cl. B60T 8/40; B60T 8/175; B60T 8/1755; B60T 8/48

(52) U.S. Cl. CPC B60T 8/4059; B60T 8/4827; B60T 8/175; B60T 8/1755; B60T 2270/306

(57) ABSTRACT

An electronic vehicle stability control system includes a hydraulic braking circuit having a plurality of electronically controlled valves, a plurality of pumps, a motor that operates the plurality of pumps, and a suction throttle valve that throttles flow of hydraulic fluid to at least one of the plurality of pumps. The electronic vehicle stability control system also includes a controller coupled to the hydraulic braking circuit that controls the plurality of electronically controlled valves.

### CROSS-REFERENCE TO RELATED APPLICATIONS

This application claims priority to U.S. Provisional Patent Application No. 62/107,562, filed Jan. 26, 2015, the entire contents of which are incorporated by reference herein.

### BACKGROUND

The present invention relates to electronic vehicle stability control systems, and in particular to hydraulic braking circuits used in electronic vehicle stability control systems.

Electronic vehicle stability control systems improve a vehicle's stability by detecting and reducing loss of wheel traction (i.e., skidding) on the road. These systems use hydraulic braking circuits to quickly and automatically apply hydraulic braking fluid pressure to selected wheels to control or steer the vehicle. Electronic vehicle stability control systems are typically built on top of, or in conjunction with, anti-lock braking systems, which prevent the vehicle wheels from locking. Electronic vehicle stability control systems also are used in some vehicles to prevent rollover, to provide emergency braking, to provide pedestrian protection, to provide lateral acceleration control, or to otherwise provide selected braking to control and stabilize the vehicle, preventing injury to the passengers and to those outside of the vehicle.

Hydraulic brake fluid consumption is typically higher in larger vehicles (e.g., medium or heavy-sized trucks) than in smaller vehicles. Thus, electronic vehicle stability control systems in larger vehicles must work harder, and faster, to build up a high flow rate and delivery of hydraulic brake fluid. To meet these demands, some electronic vehicle stability control systems include pre-charged high pressure accumulators within the hydraulic braking circuits. However, use of a pre-charged high pressure system requires continuous build-up and storage of energy at levels which are not needed under normal driving conditions which results in significant wear on system components (e.g., valves), resulting in increased maintenance and/or replacement of the components.

### SUMMARY

In one aspect, the invention provides an electronic vehicle stability control system that includes a hydraulic braking circuit having a plurality of electronically controlled valves, a plurality of pumps, a motor that operates the plurality of pumps, and a suction throttle valve that throttles flow of hydraulic fluid to at least one of the plurality of pumps. The electronic vehicle stability control system also includes a controller coupled to the hydraulic circuit that controls the plurality of electronically controlled valves.

In another aspect, the invention provides an electronic vehicle stability control system that includes a brake pedal, a master cylinder coupled to the brake pedal, a first set of wheels, a second set of wheels, and a hydraulic braking system coupled to the master cylinder. The hydraulic braking system includes a first hydraulic braking circuit that directs hydraulic fluid from the master cylinder to the first set of wheels, and a second hydraulic braking circuit that directs hydraulic fluid from the master cylinder to the second set of wheels. Each of the first hydraulic braking circuit and the second hydraulic braking circuit includes a plurality of electronically controlled valves, a plurality of pumps, and a suction throttle valve that throttles flow of hydraulic fluid to at least one of the plurality of pumps. The electronic vehicle stability control system also includes a controller coupled to the hydraulic braking system that controls the plurality of electronically controlled valves.

In another aspect, the invention provides a method of operating an electronic stability control system. The method includes directing hydraulic fluid to a plurality of pumps within a hydraulic braking circuit, and throttling a flow of the hydraulic fluid to at least one of the pumps with a suction throttle valve.

Other independent aspects of the invention will become apparent by consideration of the detailed description and accompanying drawings.

### BRIEF DESCRIPTION OF THE DRAWINGS

FIG. 1 is schematic illustration of an electronic vehicle stability control system according to one construction, having two piston pumps and an electronically controlled suction throttle valve that throttles one of the piston pumps.

FIG. 2 is schematic illustration of an electronic vehicle stability control system according to another construction, having two piston pumps and a passively controlled suction throttle valve that throttles one of the piston pumps.

FIG. 3 is schematic illustration of an electronic vehicle stability control system according to another construction, having three piston pumps and a passively controlled suction throttle valve that throttles one of the piston pumps.

FIG. 4 is schematic illustration of an electronic vehicle stability control system according to another construction, having three piston pumps and a passively controlled suction throttle valve that throttles two of the piston pumps.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

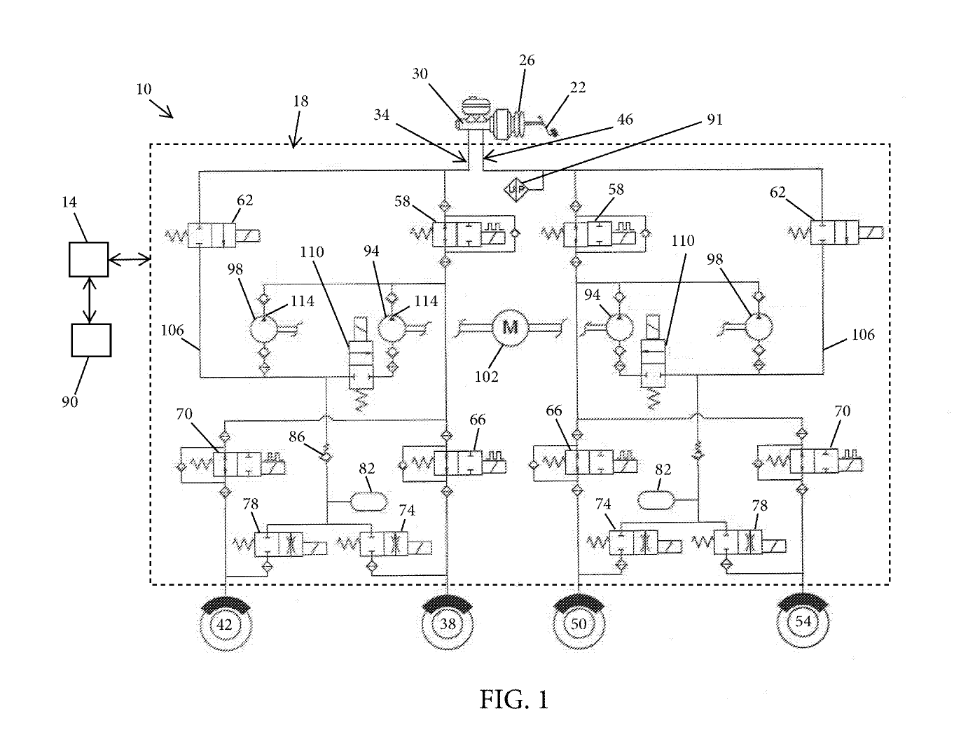

FIG. 1 illustrates an electronic vehicle stability control system 10 that includes a controller 14 and a hydraulic braking system 18 coupled to the controller 14. The electronic vehicle stability control system 10 also includes a brake pedal 22, a booster 26, and a master cylinder 30. The hydraulic braking system 18 includes a first hydraulic braking circuit 34 that extends from the master cylinder 30. The first hydraulic braking circuit 34 provides hydraulic braking fluid to a first set of vehicle wheels 38, 42. The hydraulic braking system 18 further includes a second hydraulic braking circuit 46 that also extends from the master cylinder 30. The second hydraulic braking circuit 46 provides hydraulic braking fluid to a second set of vehicle wheels 50, 54. In the illustrated construction, the first set of vehicle wheels 38, 42 includes a left, rear wheel 38 and a right, rear wheel 42. The second set of vehicle wheels 50, 54 includes a left, front wheel 50 and a right, front wheel 54. However, other constructions include different arrangements of hydraulic braking circuits and vehicle wheels. For example, in some constructions, the first set of vehicle wheels 38, 42 includes a left, rear wheel 38 and a right, front wheel 42, and the second set of vehicle wheels 50, 54 includes a left, front wheel 50 and a right, rear wheel 54. In some constructions the hydraulic braking system 18 includes just a single hydraulic braking circuit that delivers hydraulic braking fluid to four (or more) vehicle wheels.

With continued reference to FIG. 1, the first hydraulic braking circuit 34 includes a system pressure valve 58 and a prime valve 62. The system pressure valve 58 and the prime valve 62 are both electronically controlled solenoid valves. During a normal braking condition (i.e., no loss of traction in the wheels), hydraulic fluid is pushed from the master cylinder 30 through the system pressure valve 58 and through first and second normally open inlet valves 66, 70 (e.g., electronically controlled solenoid valves) to allow build-up of hydraulic pressure at the wheels 38, 42. Normal braking does not require any valve actuation.

With continued reference to FIG. 1, the first hydraulic braking circuit 34 further includes a first outlet valve 74, a second outlet valve 78, a low pressure accumulator 82, and a check valve 86. In the illustrated construction, the first outlet valve 74 and the second outlet valve 78 are both electronically controlled solenoid valves, and are one-way valves that when opened permit hydraulic fluid to move in a direction (upwardly in FIG. 1) toward the low pressure accumulator 82. During the normal braking condition, the first outlet valve 74 and the second outlet valve 78 are both closed. However, if the controller 14 determines that the hydraulic pressure at one or more of the wheels 38, 42 is excessive or likely to exceed a traction limit or result in a wheel lock, the controller 14 closes the respective inlet valve(s) 66, 70 and opens one or both of the first and second outlet valves 74, 78 to bleed hydraulic fluid to the accumulator 82.

With continued reference to FIG. 1, the controller 14 is coupled to at least one vehicle sensor 90. The vehicle sensors 90 provide input information to the controller 14, such as the relative wheel speeds of the wheels 38, 42, 50, 54, the yaw rate of the vehicle, vehicle accelerations, steering angle of the drivers wheel etc., that allows the controller 14 to determine whether to utilize the normal braking condition, or whether a different braking condition should be applied.

As illustrated in FIG. 1, the first hydraulic braking circuit 34 includes a first pump 94, a second pump 98, and a motor 102. The first and second pumps 94, 98 are piston pumps, although other constructions include different types of pumps. If the controller 14 determines that the vehicle rotates about its vertical axis in an unstable manner or an autonomous braking of any number of wheels is necessary, (i.e., due to a detected occurrence of vehicle yaw), the controller 14 may activate the motor 102, which drives both of the first and second pumps 94, 98 to draw hydraulic fluid. The controller 14 will then close the system pressure valve 58 and open the prime valve 62 to provide a line of suction 106 to the pumps. Depending on the desired fluid pressure gradient, the controller 14 may or may not actuate a throttle suction valve 110 to open the line of suction to pump 94. The pumps 94, 98, may also draw hydraulic fluid from the accumulator 82 through the check valve 86 in the event that there is brake fluid in the accumulator. Thus, as the pumps 94, 98 operate, they build up the hydraulic fluid pressure and/or the flow rate within the first hydraulic braking circuit 34, as they pump hydraulic fluid toward the inlet valves 66, 70. If both of the wheels 38, 42 require added hydraulic fluid pressure and/or flow rate to brake a wheel, then the controller 14 ensures that both inlet valves 66, 70 are open. If only one of the wheels 38, 42 requires added hydraulic fluid pressure and/or flow rate to regain traction, then the controller 14 ensures that only the corresponding inlet valve 66 or 70 for that wheel 38 or 42 is open.

With continued reference to FIG. 1, the suction throttle valve 110 throttles a flow of the hydraulic fluid to at least one of the pumps 94, 98. In the illustrated construction, the suction throttle valve 110 is an electronically controlled solenoid valve that when activated, opens the suction fluid path to the second pump 94. Other constructions include different types of suction throttle valves 110. In the construction depicted in FIG. 1, the suction throttle valve 110 is activated by the controller 14 to allow the flow of hydraulic fluid to the pump 94; in the unactivated condition, suction throttle valve 110 shuts off the suction path to pump 94. The suction valve 110 can be constructed as a normally open or normally closed valve.

In some constructions, the controller 14 activates and uses both the first pump 98 and the second pump 94 during a low pressure condition in the first hydraulic braking circuit 34 (i.e., when only a small build-up of hydraulic fluid pressure and/or flow rate is needed for the wheel or wheels 38, 42 to achieve the target braking pressure), and uses only the pump 94 during a high pressure condition in the first hydraulic braking circuit 34 (i.e., when a larger build-up of hydraulic fluid pressure and/or flow rate is needed for the wheel or wheels 38, 42 to achieve the target braking pressure).

By using both pumps 94, 98 during the low pressure condition, the first hydraulic braking circuit 34 is able to build up hydraulic fluid pressure and/or flow rate more quickly, in a short response time to the wheels 38, 42. By using a single pump 98 during the high pressure condition, the first hydraulic braking circuit 34 is still able to further build hydraulic fluid pressure and/or flow rate, but the stress on the motor 102 is relieved, since the motor 102 then only has a single pump 98 which is doing work, to operate.

In some constructions, when the pressure of the hydraulic fluid at one or more of the pump outlets 114 reaches a predetermined threshold value (e.g., as measured by a sensor 91, illustrated in FIG. 1, attached hydraulically inside the hydraulic braking system 18, and in some constructions corresponding to a maximum torque that the motor 102 may handle) the controller 14 activates the suction throttle valve 110 in such a way that it closes off all flow of hydraulic fluid to pump 94. In some constructions, the suction throttle valve 110 is a variable valve, such that as the pressure of the hydraulic fluid at one or more of the pump outlets 114 increases, the controller 14 activates the suction throttle valve 110 to incrementally throttle off the flow of hydraulic fluid to the pump 94.

Other constructions include different numbers of pumps 94, 98 than that illustrated. For example, in some constructions the first hydraulic braking circuit 34 includes three pumps, four pumps, or more. Additionally, in some constructions the suction throttle valve 110 throttles more than one pump (e.g., two piston pumps).

In some constructions, the first hydraulic braking circuit 34 includes multiple pumps, with at least one of the pumps having a larger displacement than another pump. In some constructions, the first hydraulic braking circuit 34 includes multiple pumps, with at least one of the pumps having a larger displacement than another pump, and where the suction throttle valve 110 throttles the flow of hydraulic fluid to at least one of the pumps. In some constructions, the first hydraulic braking circuit 34 includes pumps of different sizes, wherein a larger one of the pumps, or the largest of the pumps, is only activated during the low pressure condition.

Use of multiple pumps 94, 98 with a throttle suction valve enables a standard system with only minor modifications to be able to displace more fluid volume at low fluid pressures and ensures that the hydraulic unit's and the vehicle's power net limitations are not exceeded at high pressures. Since most braking maneuvers are carried out at relatively low hydraulic pressures, the operation of an additional pump in each circuit at low pressures allows a decrease in necessary motor speed, thus enabling improvements in noise characteristics during normal operation.

With continued reference to FIG. 1, while only the first hydraulic braking circuit 34 has been described above, the second hydraulic braking circuit 46 is identical in operation. Thus, the same disclosure provided above similarly applies to the second hydraulic braking circuit 46.

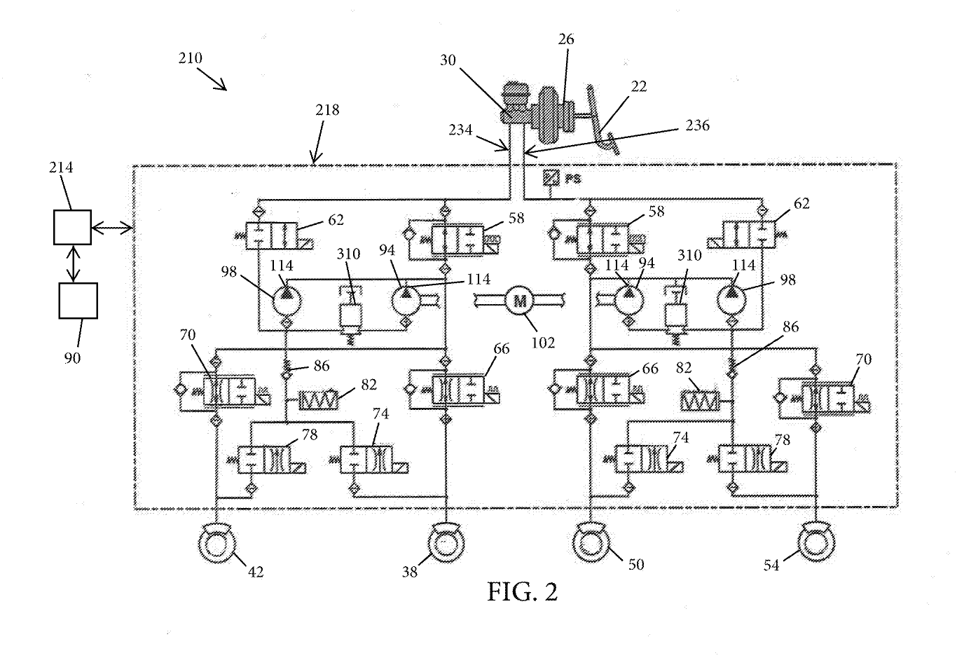

FIG. 2 illustrates an electronic vehicle stability control system 210 that includes a controller 214 and a hydraulic braking system 218 coupled to the controller 214. The hydraulic braking system 218 is similar to the hydraulic braking system 18 described above. For example, the hydraulic braking system 218 includes a first hydraulic braking circuit 234 (and second braking circuit 236) having the same system pressure valve 58, prime valve 62, first inlet valve 66, second inlet valve 70, first outlet valve 74, second outlet valve 78, low pressure accumulator 82, check valve 86, first pump 94, and second pump 98 as the hydraulic braking system 18.

In contrast, however, the first hydraulic braking circuit 234 (and second braking circuit 236) includes a suction throttle valve 310 that is a passive element (e.g., a mechanical spring-loaded piston), as opposed to an electronically controlled suction throttle valve like the suction throttle valve 110 in FIG. 1. In some constructions, the suction throttle valve 310 is set to automatically and immediately close off the flow of hydraulic fluid to pump 94 when a predetermined threshold value is reached at one or more of the pump outlet 114, or to incrementally close off the flow of hydraulic fluid to the first pump 94 as the hydraulic fluid pressure rises at one or more of the pump outlets 114. In some constructions, the suction throttle valve 310 may be incorporated into an existing hydraulic circuit without impacting or substantially impacting an interface of a controller, because of the passive nature of the suction throttle valve 310 and the lack of any communication between the suction throttle valve 310 and a controller.

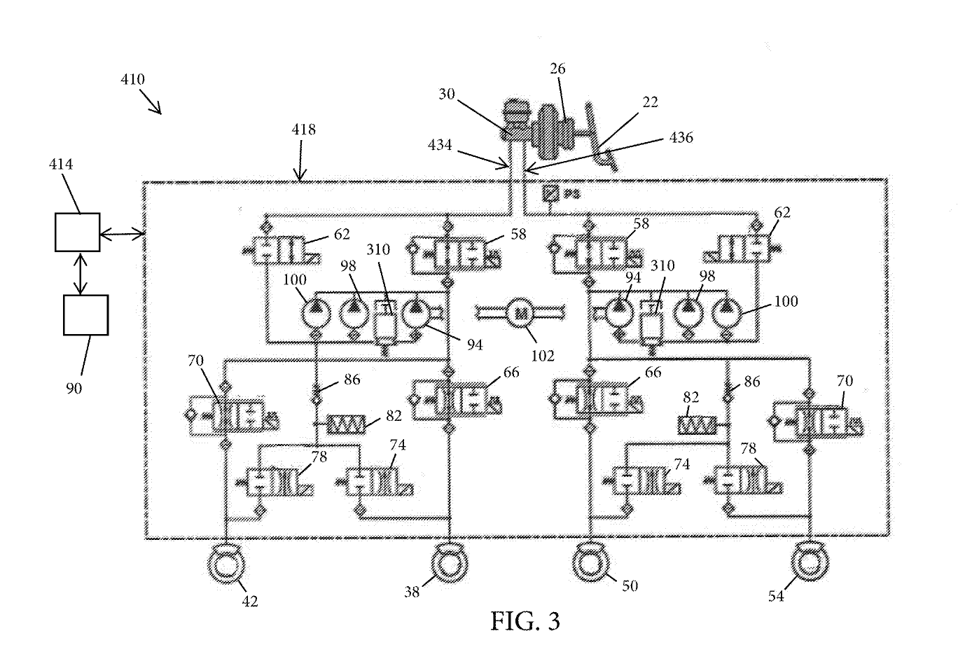

FIG. 3 illustrates an electronic vehicle stability control system 410 that includes a controller 414 and a hydraulic braking system 418 coupled to the controller 414. The hydraulic braking system 418 is similar to the hydraulic braking system 218 described above. For example, the hydraulic braking system 418 includes a first hydraulic braking circuit 434 (and second braking circuit 436) having the same pilot valve 58, prime valve 62, first inlet valve 66, second inlet valve 70, first outlet valve 74, second outlet valve 78, low pressure accumulator 82, check valve 86, first pump 94, second pump 98, and suction throttle valve 310 as the hydraulic braking system 218.

In contrast, however, the first hydraulic braking circuit 434 (and second braking circuit 436) includes a third pump 100. As illustrated in FIG. 3, the suction throttle valve 310 throttles the pump 94, while the second and third pumps 98, 100 are not throttled by the suction throttle valve 310.

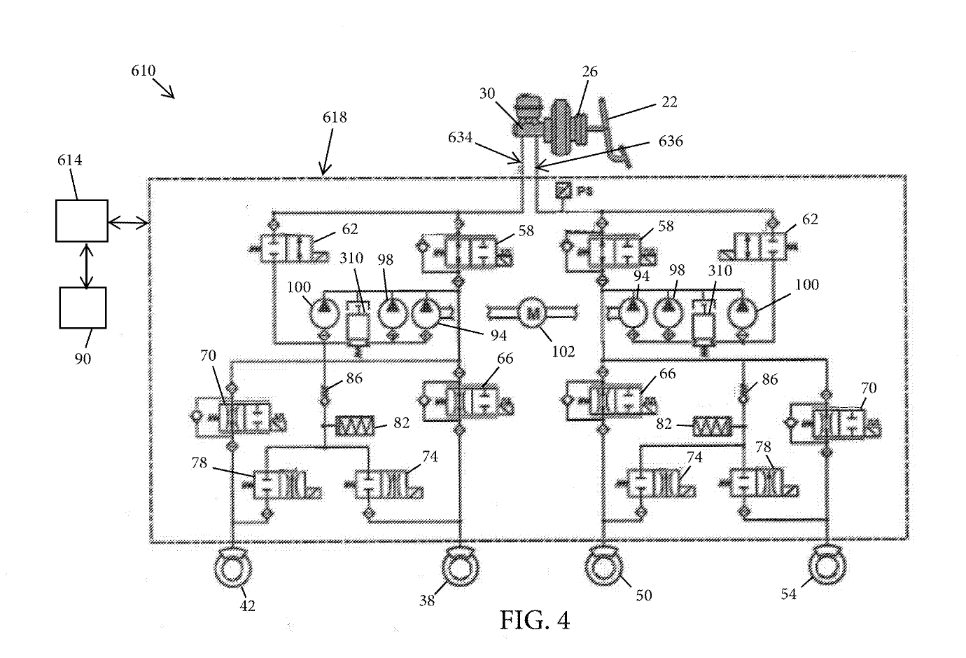

FIG. 4 illustrates an electronic vehicle stability control system 610 that includes a controller 614 and a hydraulic braking system 618 coupled to the controller 614. The hydraulic braking system 618 is similar to the hydraulic braking system 418 described above. For example, the hydraulic braking system 618 includes a first hydraulic braking circuit 634 (and second braking circuit 636) having the same system pressure valve 58, prime valve 62, first inlet valve 66, second inlet valve 70, first outlet valve 74, second outlet valve 78, low pressure accumulator 82, check valve 86, first pump 94, second pump 98, third pump 100, and suction throttle valve 310 as the hydraulic braking system 418.

In contrast, however, the suction throttle valve 310 throttles both the pump 94 and the pump 98, while a third pump 100 is not throttled by the suction throttle valve 310.

Although the electronic vehicle stability control systems 10, 210, 410, 610 have been described in the context of a large sized vehicle, the electronic vehicle stability control systems described herein are applicable to other vehicles as well, including vehicles of smaller or larger size, and with different numbers of wheels than that illustrated.

Various features and advantages of the invention are set forth in the following claims.

What is claimed is:

1. An electronic vehicle stability control system comprising:
a hydraulic braking circuit having a plurality of electronically controlled valves, a plurality of pumps, a motor that operates the plurality of pumps, and a suction throttle valve that throttles flow of hydraulic fluid to at least one of the plurality of pumps; and
a controller coupled to the hydraulic braking circuit that controls the plurality of electronically controlled valves.

2. The electronic vehicle stability control system of claim 1, wherein the suction throttle valve is an electronically controlled valve.

3. The electronic vehicle stability control system of claim 1, wherein the suction throttle valve is a passively controlled valve.

4. The electronic vehicle stability control system of claim 1, wherein the plurality of pumps is two pumps, and wherein the suction throttle valve throttles flow of hydraulic fluid to one of the two pumps.

5. The electronic vehicle stability control system of claim 1, wherein the plurality of pumps is three pumps, and wherein the suction throttle valve throttles flow of hydraulic fluid to one of the three pumps.

6. The electronic vehicle stability control system of claim 1, wherein the plurality of pumps is three pumps, and wherein the suction throttle valve throttles flow of hydraulic fluid to two of the three pumps.

7. The electronic vehicle stability control system of claim 1, wherein the suction throttle valve is a variable valve, such that as a pressure of hydraulic fluid at an outlet of one of the plurality of pumps incrementally increases, the controller activates the suction throttle valve to incrementally throttle off hydraulic fluid flow to the one of the plurality of pumps.

8. The electronic vehicle stability control system of claim 1, wherein the suction throttle valve is a passive, variable valve, such that as a pressure of hydraulic fluid at an outlet of one of the plurality of pumps incrementally increases, the suction throttle valve automatically incrementally throttles off hydraulic fluid flow to the one of the plurality of pumps.

9. The electronic vehicle stability control system of claim 1, wherein when a pressure of hydraulic fluid at an outlet of one of the plurality of pumps reaches a predetermined threshold, the controller is configured to activate the suction throttle valve to completely close off hydraulic fluid flow to the one of the plurality of pumps.

10. The electronic vehicle stability control system of claim 1, wherein when a pressure of hydraulic fluid at an outlet of one of the plurality of pumps reaches a predetermined threshold, the suction throttle valve automatically completely closes off hydraulic fluid flow to the one of the plurality of pumps.

11. The electronic vehicle stability control system of claim 1, wherein the plurality of electronically controlled valves includes a pilot valve, a prime valve, a first inlet valve, a second inlet valve, a first outlet valve, a second outlet valve, and wherein the hydraulic braking circuit further includes a low pressure accumulator and a check valve.

12. The electronic vehicle stability control system of claim 11, wherein the controller is configured to close the pilot valve, open the prime valve, and operate the motor to run the plurality of pumps when a wheel of a vehicle loses traction, and wherein the suction throttle valve closes off flow to one of the plurality of pumps when a hydraulic fluid pressure at an outlet of the one of the plurality of pumps reaches a predetermined threshold.

13. The electronic vehicle stability control system of claim 11, wherein during a normal braking condition, the controller is configured to close the prime valve, open the pilot valve, open the first inlet valve, and open the second inlet valve.

14. The electronic vehicle stability control system of claim 11, further comprising a plurality of sensors coupled to the controller that provide wheel speed information to the controller.

15. The electronic vehicle stability control system of claim 11, wherein the first inlet valve is coupled to a first wheel of a vehicle, and the second inlet valve is coupled to a second wheel of a vehicle.

16. An electronic vehicle stability control system comprising:
a brake pedal;
a master cylinder coupled to the brake pedal;
a first set of wheels;
a second set of wheels;
a hydraulic braking system coupled to the master cylinder, the hydraulic braking system including a first hydraulic braking circuit that directs hydraulic fluid from the master cylinder to the first set of wheels, and a second hydraulic braking circuit that directs hydraulic fluid from the master cylinder to the second set of wheels, wherein each of the first hydraulic braking circuit and the second hydraulic braking circuit includes a plurality of electronically controlled valves, a plurality of pumps, and a suction throttle valve that throttles flow of hydraulic fluid to at least one of the plurality of pumps; and
a controller coupled to the hydraulic braking system that controls the plurality of electronically controlled valves.

17. The electronic vehicle stability control system of claim 16, wherein the suction throttle valve is an electronically controlled valve.

18. The electronic vehicle stability control system of claim 16, wherein the suction throttle valve is a passively controlled valve.

19. The electronic vehicle stability control system of claim 16, wherein the plurality of electronically controlled valves includes a pilot valve, a prime valve, a first inlet valve, a second inlet valve, a first outlet valve, and a second outlet valve, and wherein each of the first hydraulic braking circuit and the second hydraulic braking circuit further includes a low pressure accumulator and a check valve.

20. The electronic vehicle stability control system of claim 19, wherein the controller is configured to close the pilot valve, open the prime valve, and operate the plurality of pumps in the first hydraulic braking circuit when the controller determines that a build-up of hydraulic braking pressure should be executed, and wherein the suction throttle valve is configured to close off flow to one of the plurality of pumps in the first hydraulic braking circuit when a hydraulic fluid pressure at an outlet of the one of the plurality of pumps reaches a predetermined threshold.

21. A method of operating an electronic stability control system comprising:
directing hydraulic fluid to a plurality of pumps within a hydraulic braking circuit; and
throttling a flow of the hydraulic fluid to at least one of the pumps with a suction throttle valve.

22. The method of claim 21, wherein the step of directing hydraulic fluid to a plurality of pumps includes closing a pilot valve and opening a prime valve within the hydraulic circuit, thereby opening a suction line to the plurality of pumps.

23. The method of claim 21, wherein the step of throttling the flow includes throttling the flow to only a single pump.

24. The method of claim 21, wherein the step of throttling the flow includes throttling the flow to at least two pumps.

25. The method of claim 21, wherein the suction throttle valve is a variable valve, and wherein when a pressure of hydraulic fluid at an outlet of one of the plurality of pumps incrementally increases, the method includes activating the suction throttle valve with a controller to incrementally throttle off hydraulic fluid flow to the one of the plurality of pumps.

26. The method of claim 21, wherein the suction throttle valve is a passive, variable valve, and wherein as a pressure of hydraulic fluid at an outlet of one of the plurality of pumps incrementally increases, the method includes the suction throttle valve automatically incrementally throttling off hydraulic fluid flow to the one of the plurality of pumps.

27. The method of claim 21, wherein when a pressure of hydraulic fluid at an outlet of one of the plurality of pumps reaches a predetermined threshold, the method includes activating the suction throttle valve with a controller to completely close off hydraulic fluid flow to the one of the plurality of pumps.

28. The method of claim 21, wherein when a pressure of hydraulic fluid at an outlet of one of the plurality of pumps reaches a predetermined threshold, the method includes the suction throttle valve automatically completely closing off hydraulic fluid flow to the one of the plurality of pumps.

29. The electronic vehicle stability control system of claim 21, further comprising closing a pilot valve, opening a prime valve, and operating a motor to run the plurality of pumps when a wheel of a vehicle loses traction, and wherein the method further includes closing off flow to one of the plurality of pumps with the suction throttle valve when a hydraulic fluid pressure at an outlet of the one of the plurality of pumps reaches a predetermined threshold.
